(19) United States
(12) Patent Application Publication
(10) Pub. No.: US 2015/0352474 A1
(43) Pub. Date: Dec. 10, 2015

(54) QUICK CONNECT FILTERS AND FILTER ASSEMBLIES

(71) Applicant: CUMMINS FILTRATION IP, INC., Columbus, IN (US)

(72) Inventors: Charles W. Hawkins, Saprta, TN (US); Ismail C. Bagci, Cookeville, TN (US); Anil I. Sawant, Pune (IN); Bradley W. Long, Cookeville, TN (US)

(21) Appl. No.: 14/760,016

(22) PCT Filed: Jan. 3, 2014
(86) PCT No.: PCT/US2014/010221

§ 371 Date: Jul. 9, 2015

Related U.S. Application Data
(60) Provisional application No. 61/751,319, filed on Jan. 11, 2013.

(51) Int. Cl. B01D 35/30; B01D 27/10; B01D 27/08

(52) U.S. Cl. CPC B01D 35/306; B01D 27/08; B01D 27/10

(57) ABSTRACT

Quick connect mechanisms between a fluid filter and a head that permits quick connection/disconnection between the two. The mechanisms clamp the filter shell in place with a plurality of radially displaceable locking elements. When the filter is inserted into the head, an element that controls the radial displacement of the locking element is rotated to radially displace the locking elements and lock the shell in place. External sealing is achieved by the means of suitable sealing elements, for example a compression face seal and/or a radial O-ring seal. The clamping force comes from the rotation of the control element to a lock position which displaces the locking elements in a radial direction to a lock position. When the control element is rotated to an unlock position, the locking elements are free to move or are actuated to an unlock position, allowing the filter to be removed.

### CROSS-REFERENCE TO RELATED APPLICATIONS

This application claims priority to U.S. Provisional Application No. 61/751,319 filed Jan. 11, 2013, incorporated herein by reference in its entirety.

### FIELD

This disclosure generally pertains to the field of filtration, and more particularly to designs for quick connecting a fluid filter to a filter head structure.

### BACKGROUND

Many current filter service methods require tools to connect and/or remove the filter. In addition, some filters require disposal of the complete filter.

### SUMMARY

Quick connect mechanisms between a fluid filter and a head are described that permit quick connection/disconnection between the two. No tools are required and only a filter cartridge needs to be serviced with the filter shell being reused. In another embodiment, the entire filter is disposed of during servicing and replaced with a new filter. Less time is needed for a filter change. In addition, no threads are required to connect the filter to the head.

The quick connection mechanisms clamp the filter shell in place with a plurality of radially displaceable locking elements. The locking elements are arranged so there are a plurality, for example at least 4 or more, of contact points with the shell. When the filter is inserted into the head, an element that controls the radial displacement of the locking element is rotated to radially displace the locking elements and lock the shell in place. External sealing is achieved by the means of suitable sealing elements, for example a compression face seal and/or a radial O-ring seal.

The clamping force comes from the rotation of the radial displacement control element to a lock position which displaces the locking elements in a radial direction to a lock position. When the radial displacement control element is rotated to an unlock position, the locking elements are free to move or are actuated to an unlock position to allow the filter to be removed.

In one embodiment, a fluid filter includes a generally cylindrical shell defining an interior space. The shell includes a wall having a first, open end and a second, closed end. A circumferentially continuous, radially outward or inward facing locking channel is formed in the shell adjacent to the first, open end. In addition, a seal is adjacent to the open end for sealing with a filter head, a filter element disposed within the interior space of the shell.

In another embodiment, a fluid filter system includes the fluid filter and a filter head to which the fluid filter mounts. The filter head includes a quick connect mechanism that engages with the locking channel to detachably connect the fluid filter to the filter head.

The filter head can include a housing defining an interior space that in use receives a portion of the fluid filter therein, a fluid inlet and a fluid outlet. The quick connect mechanism can include a plurality of radially displaceable locking elements and a control element that is rotatably disposed on the housing for rotation between an unlocked position and a locked position. The control element is engaged with the locking elements to control a radial position of the locking elements.

### DRAWINGS

FIG. 1 is an isometric perspective showing a filter assembly including a fluid filter connected to a head using a first embodiment of a quick connect mechanism described herein, with the quick connect mechanism in a locked position.

FIG. 2a is a longitudinal cross-sectional view of the filter assembly of FIG. 1.

FIG. 2b is an exploded view of the filter assembly of FIG. 1.

FIG. 3 is a cross-sectional view taken along line 3-3 of FIG. 2.

FIG. 4 is a side view of the filter assembly of FIG. 1.

FIG. 5 is a bottom view of the filter assembly of FIGS. 1 and 4.

FIG. 6 is a longitudinal cross-sectional view of another embodiment of a filter assembly with a quick connect mechanism connecting the fluid filter to a head.

FIG. 7 is a detailed view of the portion contained in the circle A in FIG. 6.

FIG. 8 is a cross-sectional view taken along line 8-8 of FIG. 6.

FIG. 9 is a bottom view of the filter assembly of FIG. 6.

FIG. 10 is a longitudinal cross-sectional view of still another embodiment of a filter assembly with a quick connect mechanism connecting the fluid filter to a head.

FIGS. 11a, 11b and 11c are upper perspective, lower perspective and top views of the head of the filter assembly of FIG. 10.

FIG. 12 is a cross-sectional view taken through the head of FIGS. 11a-c showing the locking elements and the radial displacement control element in a locked position.

FIG. 13 is a top view of the head similar to FIG. 11c but with the radial displacement control element rotated to an unlock position.

FIG. 14 is a cross-sectional view taken through the head of FIG. 13 showing the locking elements and the radial displacement control element in an unlocked position.

FIG. 15 is a longitudinal cross-sectional view of a filter assembly including a fluid filter connected to a head using another embodiment of a quick connect mechanism described herein, with the quick connect mechanism in a locked position.

FIG. 16 is a close-up view of the portion in the circle B in FIG. 15.

FIG. 17 is a close-up view similar to FIG. 16 but with the quick connect mechanism in an unlocked position.

FIG. 18 is a longitudinal cross-sectional view of another example of a filter assembly that includes a fluid filter connected to a head using a quick connect mechanism that is similar to the quick connect mechanism shown in FIGS. 15-17.

FIG. 19 is a close-up view of the portion in the circle C in FIG. 18.

FIG. 20 is a longitudinal cross-sectional view of a filter assembly including a fluid filter connected to a head using another embodiment of a quick connect mechanism described herein, with the quick connect mechanism in a locked position.

FIG. 21 is a close-up view of the portion in the circle D in FIG. 20.

FIG. 22 is a longitudinal cross-sectional view of a filter assembly including a fluid filter connected to a head using another embodiment of a quick connect mechanism described herein, with the quick connect mechanism in a locked position.

FIG. 23 is a close-up view of the portion in the circle E in FIG. 22.

### DETAILED DESCRIPTION

Quick connect mechanisms between a fluid filter and a head are described that permit quick connection/disconnection between the two. Both the fluid filter and the head include innovations to implement the quick connect mechanisms.

The fluid filter includes a shell, a circumferentially continuous inward or outward facing locking channel formed in the shell for engagement with the quick connect mechanism, and a seal for sealing with the filter head. The locking channel can have any configuration, for example generally semi-circular or rectangular, that is suitable for engagement by the locking elements to lock the filter to the head.

The quick connect mechanism is mounted in the head and includes a plurality of radially displaceable locking elements. A rotatable radial displacement control element is mounted on the head that controls the radial displacement of the locking elements. In one embodiment illustrated herein and described below, the locking elements are balls. In another embodiment, the locking elements are pins. However, the locking elements can have any configuration suitable for locking the fluid filter to the head.

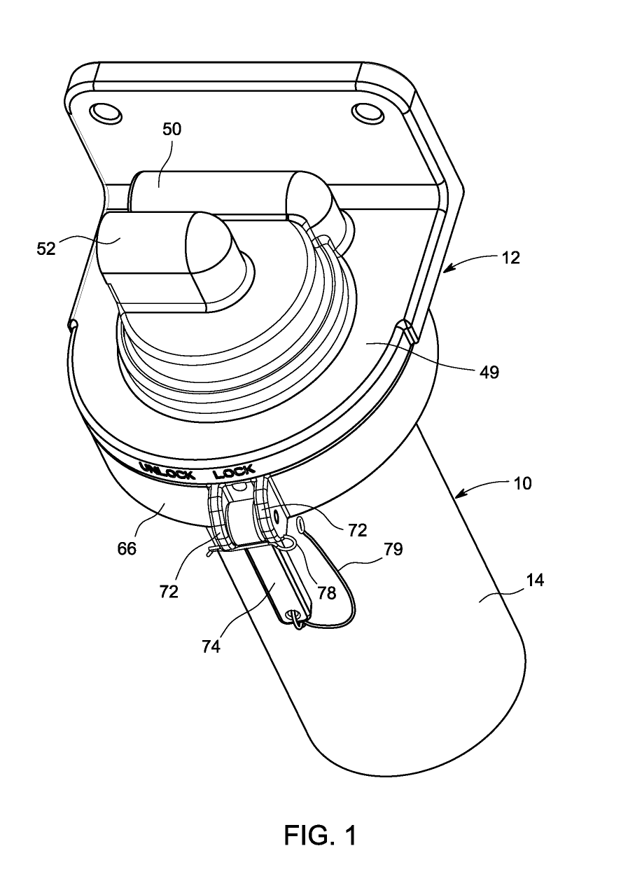

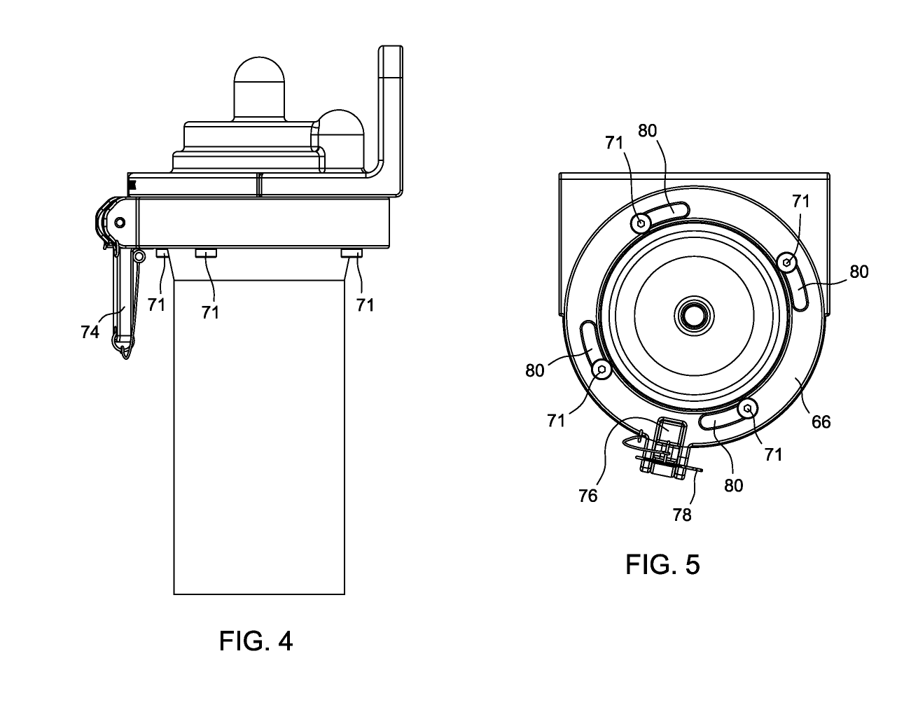

With reference initially to FIGS. 1-5, a quick connect mechanism between a fluid filter 10 and a head 12 is illustrated. The fluid filter 10, the head 12, and/or connection between the fluid filter and the head can be used in any number of fluid systems including, but not limited to, a fuel or oil filtration system, for example on an engine such as a diesel or gasoline engine, a hydraulic fluid filtration system in a hydraulic system, other engine fluid filtration systems on diesel or gasoline engines, as well as filtration systems used in non-engine applications. In one exemplary application, the fluid filter 10 is used in a fuel system for filtering fuel, for example diesel fuel.

In the illustrated example, the fluid filter 10 includes a shell 14 defining an interior space 16. A replaceable filter cartridge 18 is removably disposed within the interior space. In this embodiment, during servicing, the shell 14 is intended to be reused and the filter cartridge 18 is removed and replaced with a new filter cartridge. In another embodiment, the entire fluid filter 10 is discarded and replaced with a new shell and filter cartridge during servicing, in which case the shell and filter cartridge can be permanently connected to one another or the filter cartridge can be removable from the shell.

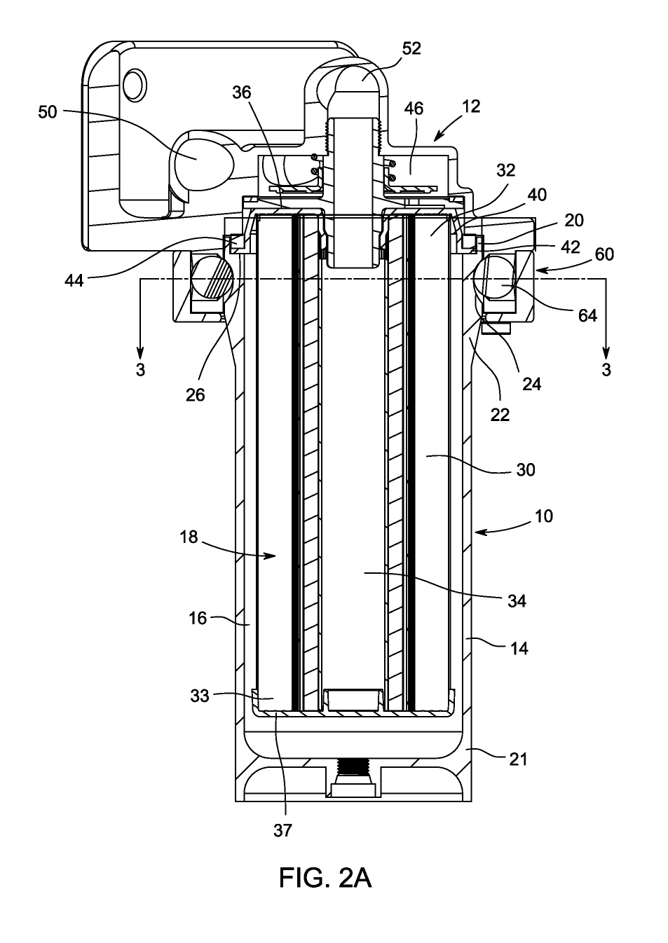

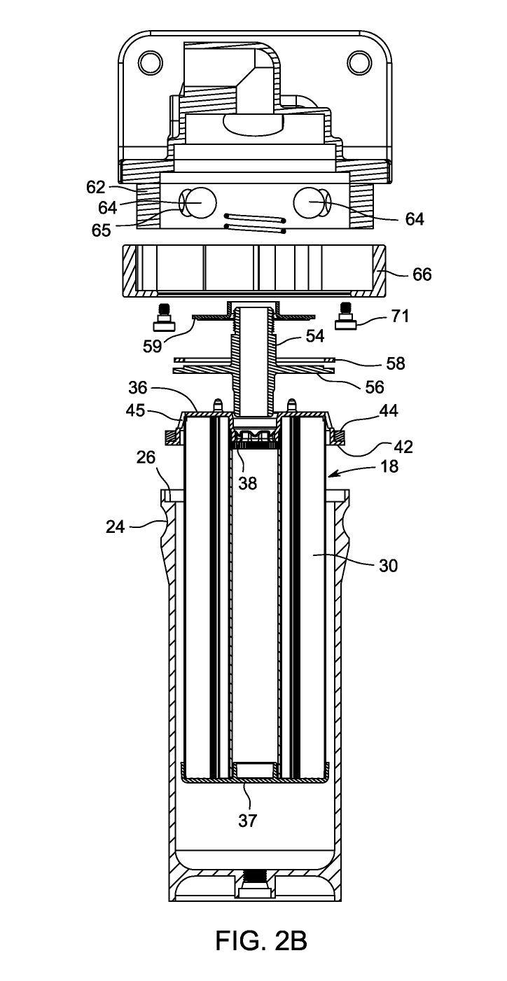

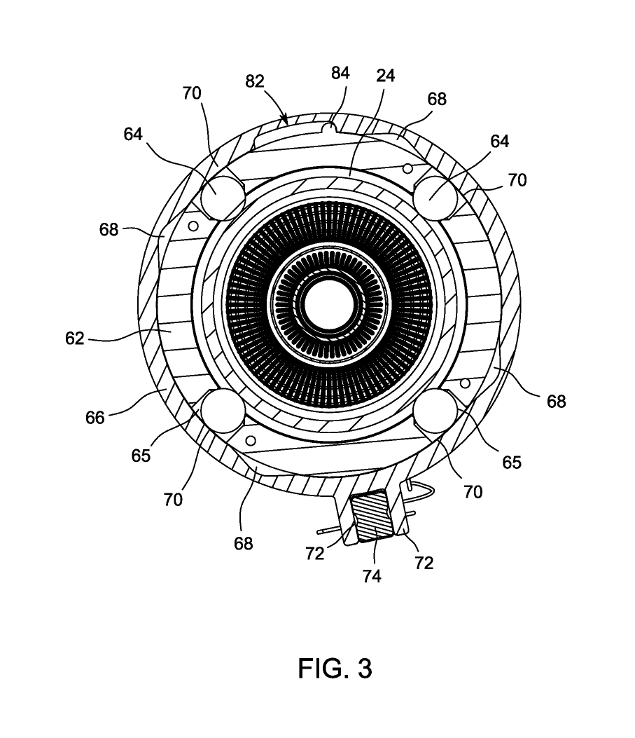

With reference to FIGS. 2a, 2b and 3, the shell 14 can be made of any material suitable for use in a fluid filter. Examples of materials include metal and plastic. The shell 14 can be generally cylindrical in shape and includes a wall having a first, open end 20 and a second, closed end 21. The wall of the shell 14 has a generally constant radial thickness over most of its length, but has an enlarged thickness section 22, with a radial thickness that is larger than the thickness of the lower portion of the wall, adjacent to the open end 20. A circumferentially continuous, generally semi-circular, radially outward facing exterior locking channel 24 is formed in the enlarged thickness section 22. The channel 24 is configured to engage with locking elements of a quick connect mechanism described further below.

The shell 14 also includes an interior shelf 26 adjacent to the open end 20 that faces in an axial direction toward the head 12 and faces away from the closed end 21 of the shell. In use, the shelf 26 supports the filter cartridge 18 as discussed further below.

With continued reference to FIGS. 2a and 2b, the filter cartridge 18 includes a ring of filtration media 30 having a first end 32 and a second end 33 and circumscribing a central cavity 34 having a longitudinal axis. An endplate 36 is fixed to the first end 32 to close the first end of the media 30. An endplate 37 is also fixed to the second end 33 of the media to close the second end. In the illustrated example, the endplate 37 is closed so that no fluid can flow through the endplate 37. However, in one embodiment, the endplate 37 can have one or more passages to allow flow of fluid therethrough and/or allow passage of a fluid passageway member through which fluid can flow.

The endplate 36 has a central opening 38 that is in fluid communication with the central cavity 34 of the media 30. A support 40 extends from the periphery of the endplate 36 to support the endplate, and thus the filter cartridge 18, on the shelf 26. The support 40 extends in a direction toward the second end of the media and is angled radially outwardly as well to a radial extending lip 42 that in use rests on the shelf 26 as shown in FIG. 2a.

A circumferential sealing gasket 44 is disposed on the radial lip 42. The gasket 44 provides a seal between the filter cartridge and the head 12 to prevent fluid leakage to the exterior. In the illustrated embodiment, the seal 44 is spaced from and not disposed within the locking channel 24.

A plurality of openings 45 are formed in the support 40 radially outward of the central opening 38 and radially inward of the sealing gasket 44 to provide fluid communication between an interior space 46 of the head 12 and a space between the outer side of the filter media 30 and the wall of the shell 14. In the illustrated example, the filter cartridge is designed for outside in fluid flow, with the space between the outer side of the filter media 30 and the wall of the shell 14 being an unfiltered fluid side and the central cavity being a filtered fluid side. However, the filter cartridge could be designed for inside out fluid flow, with the central cavity 34 being an unfiltered fluid side and the space between the outer side of the filter media 30 and the wall of the shell 14 being a filtered fluid side.

Turning to FIGS. 1, 2a and 2b, the head 12 includes a housing 49 that defines an interior space that in use receives a portion of the fluid filter 10 therein. The housing includes a fluid inlet 50 that is in fluid communication with the interior space 46 and a fluid outlet 52 that is in fluid communication with the central cavity 34 via the central opening 38. A fluid outlet post 54 includes a first end that is connected to the outlet 52 by threads. A plate 56 is fixed to the outlet post 54 between the first end and the second end and extends radially therefrom. The plate 56 includes a perimeter edge having a seal 58 disposed on the perimeter edge that in use is in sealing engagement with the filter head 12 to seal incoming fluid to be filtered from outgoing filtered fluid. Further information on the construction of the outlet post and the plate can be found in U.S. Provisional Application Ser. No. 61/706964, which is incorporated herein by reference in its entirety.

As described in U.S. Provisional Application Ser. No. 61/706964, during attachment of the filter to the head, valve actuating pins on the endplate 36 are configured to extend into and through pin openings in the plate 56. When this occurs, the pins push a valve 59 upward against the bias force of a spring, breaking a seal between the valve 59 and the plate 56. Once the valve is pushed upward, fluid to be filtered can flow from the inlet 50, then radially inwardly between the valve and the plate 56, through openings in the plate 56, and then radially outwardly between the plate 56 and a central portion of the endplate 36 via channels in the bottom of the plate 56. The fluid then flows through the openings 45 to the outside of the filter media 30. The fluid then flows inwardly through the filter media into the central cavity 34, and then upwardly through the outlet post 54 to the outlet 52.

The head 12 further includes a quick connect mechanism 60 that is used to detachably fix the filter 10 to the head 12. In the illustrated example, the quick connect mechanism 60 is an external lock construction that in use surrounds the first end 20 of the filter 10 when the filter is inserted into the head 12. In one embodiment, the quick connect mechanism 60 is a ball lock construction where the locking elements are in the form of a plurality of circumferentially spaced locking balls 64. The balls 64 are radially displaceable with their radial displacement being controlled by a rotatable radial displacement control element 66 in the form of a rotatable retaining ring.

The locking balls 64 are disposed within suitable holes 65 in a skirt portion 62 of the head to allow the balls to move radially inward and outward, controlled by the control element 66. In one embodiment, there are four of the locking balls 64 that are circumferentially spaced from each other so that there are four contact points around the diameter of the shell 14. However, a smaller or larger number of locking balls could be used.

The control element 66 is mounted on and surrounds the skirt portion 62 and the balls 64 and is mounted on the skirt portion 62 to allow the control element 66 to rotate relative to the skirt portion 62 between a locked position (shown in FIGS. 1-5) and an unlocked position. As best seen in FIG. 3, the control element 66 has circumferentially alternating regions of differing radial thicknesses, with thin radial thickness regions 68 and regular or thick (i.e. thick relative to the regions 68) radial thickness regions 70. With reference to FIG. 3, at the locked position of the control element 66, the regions 70 are positioned opposite the balls 64 which forces the balls 64 to move radially inward to retain the balls within the locking channel 24. At the unlocked position, the regions 68 are positioned opposite the balls 64 which allow the balls 64 to move radially outward. In one embodiment, the control element 66 is rotatable approximately 22.5 degrees between the locked and unlocked positions. However, other rotation amounts are possible.

With reference to FIGS. 3-5, the control element 66 is mounted to the skirt portion 62 via screws 71 that extend through slots 80 formed in the base of the control element 66 and thread into suitable threaded apertures in the end of the skirt portion 62. The slots 80 allow the control element 66 to rotate relative to the skirt portion 62, with the ends of the slots 80 also acting as stops to control the amount of rotation of the control element 66. With reference to FIG. 3, alternatively or in addition to the stops provided by the slots 80, the inner circumference of the control element 66 can be provided with a slot 82 that interacts with a protrusion 84 formed on the skirt portion 62. The slot 82 and protrusion 84 act to limit the rotation of the control element 66. The stop elements 82, 84 could be reversed, with the slot 82 formed in the skirt portion 62 and the protrusion 84 formed on the control element 66.

With reference to FIGS. 1 and 3, with the control element 66 initially in the unlock position (i.e. rotated in a clockwise direction from that shown in FIGS. 1 and 3 so that the thin regions 68 are opposite the balls 64), the filter 10 is inserted into the head 12, and the control element 66 is rotated counterclockwise from the unlock position to the locked position. This causes the thick regions 70 to force the balls 64 radially inward and trap them in the locking channel 24, thereby clamping the filter in place. The filter 10 can be removed by rotating the control element 66 from the locked position to the unlock position so that the thin regions 68 are opposite the balls. The balls can then move radially outward, out of the channel 24, allowing the filter to be removed.

Rotation of the control element 66 is preferably done manually. In one embodiment, the control element includes a pair of ears 72 fixed to the outside surface thereof and a lever arm 74 is pivotally mounted to the ears 72. The lever arm 74 is pivotable approximately 90 degrees between a rotation position (shown in FIG. 9) for use in rotating the control element 66, and a locked position shown in FIGS. 1-5.

As best seen in FIG. 5, the lever arm 74 includes a lock tab 76 at the base end thereof. When the lever arm 74 is in the locked position, the lock tab 76 is disposed in a slot 77 formed in the control element 66 and a slot (not visible) formed in the skirt portion 62 of the head 12. This prevents the control element 66 from rotating during operation and releasing the quick connect mechanism.

In addition, a safety pin 78, for example an R-clip, can be secured to the ears 72 to hold the lever arm 74 at the locked position. As best seen in FIG. 1, a retaining lanyard 79 can be provided with one end fixed to the pin 78 and its opposite end fixed to the filter assembly, for example to the end of the lever arm 74. The lanyard 79 helps to prevent loss of the pin 78.

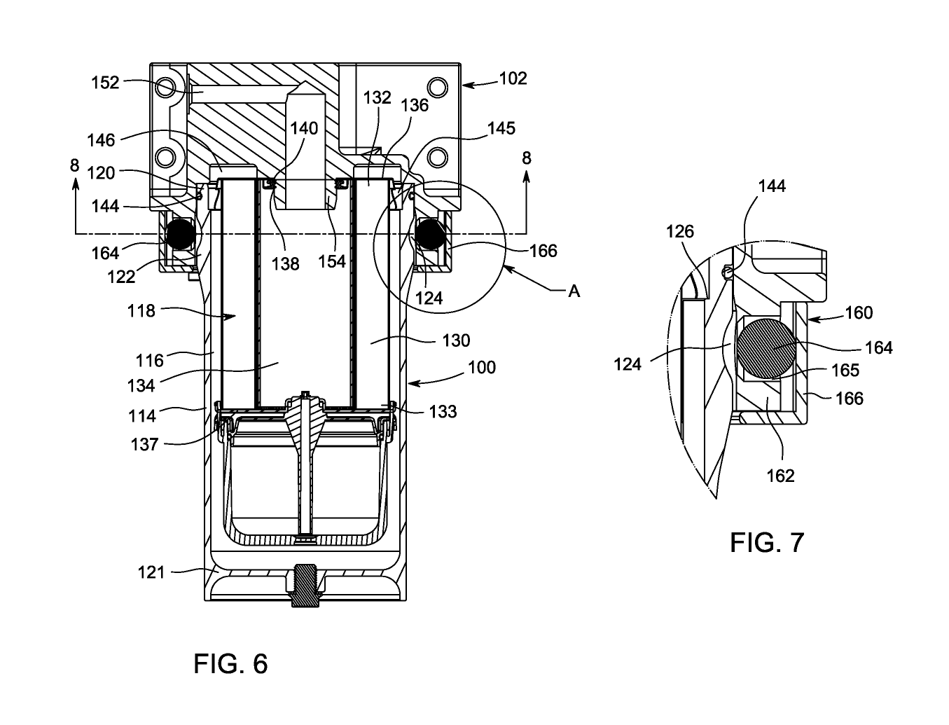

FIGS. 6-9 illustrate another embodiment of a fluid filter 100 and a filter head 102. As with the embodiment illustrated in FIGS. 1-5, the filter head 102 includes a quick connect mechanism 160 in the form of a ball lock construction.

In the illustrated example, the fluid filter 100 includes a shell 114 defining an interior space 116. A replaceable filter cartridge 118 is removably disposed within the interior space. In this embodiment, during servicing, the shell 114 is intended to be reused and the filter cartridge 118 is removed and replaced with a new filter cartridge. In another embodiment, the entire fluid filter 100 can be discarded and replaced with a new shell and filter cartridge during servicing, in which case the shell and filter cartridge can be permanently connected to one another or the filter cartridge can be removable from the shell.

The shell 114 can be made of any material suitable for use in a fluid filter. Examples of materials include metal and plastic. The shell 114 can be generally cylindrical in shape and includes a wall having a first, open end 120 and a second, closed end 121. The wall of the shell 114 has a generally constant radial thickness over most of its length, but has an enlarged thickness section 122, with a radial thickness that is larger than the thickness of the lower portion of the wall, adjacent to the open end 120. A circumferentially continuous, generally semi-circular, radially outward facing exterior locking channel 124 is formed in the enlarged thickness section 122. The channel 124 is configured to engage with locking elements of a quick connect mechanism described further below.

The shell 114 also includes an interior shelf 126 adjacent to the open end 120 that faces in an axial direction toward the head 102 and faces away from the closed end 121 of the shell. In use, the shelf 126 supports the filter cartridge 118 as discussed further below. In one embodiment, the filter cartridge 118 is nested within the shell 114, but the cartridge 118 is not fixed to the shell. In another embodiment, the filter cartridge 118 is nested within the shell 114 and is fixed within the shell.

With continued reference to FIG. 6, the filter cartridge 118 includes a ring of filtration media 130 having a first end 132 and a second end 133 and circumscribing a central cavity 134 having a longitudinal axis. An endplate 136 is fixed to the first end 132 to close the first end of the media 130. An endplate 137 is also fixed to the second end 133 of the media to close the second end. In the illustrated example, the endplate 137 is closed so that no fluid can flow through the endplate 137. However, in one embodiment, the endplate 137 can have one or more passages to allow flow of fluid therethrough and/or allow passage of a fluid passageway member through which fluid flow.

The endplate 136 has a central opening 138 that is in fluid communication with the central cavity 134 of the media 130. The central opening 138 includes a sealing gasket 140, for example an o-ring seal, that seals with a post 154 extending from the head 102 to prevent fluid leakage between the clean and dirty sides of the filter.

In addition, a circumferential sealing gasket 144 is disposed on the shell 114 adjacent to the open end 120. The gasket 144 provides a seal between the filter 100 and the head 102 to prevent fluid leakage to the exterior. In the illustrated embodiment, the seal 144 is spaced from and not disposed within the locking channel 124.

A gap 145 is formed radially outward of the central opening 138 and radially inward of the sealing gasket 144 to provide fluid communication between an interior space 146 of the head 102 and a space between the outer side of the filter media 130 and the wall of the shell 114. In the illustrated example, the filter cartridge is designed for outside in fluid flow, with the space between the outer side of the filter media 130 and the wall of the shell 114 being an unfiltered fluid side and the central cavity being a filtered fluid side. However, the filter cartridge could be designed for inside out fluid flow, with the central cavity 134 being an unfiltered fluid side and the space between the outer side of the filter media 130 and the wall of the shell 114 being a filtered fluid side.

The head 102 includes a housing 149 that defines an interior space that in use receives a portion of the fluid filter 100 therein. The housing includes a fluid inlet that is in fluid communication with the interior space 146 and a fluid outlet 152 that is in fluid communication with the central cavity 134 via the central opening 138. The head 102 includes a fluid outlet post 154 that in use is in sealing engagement with the sealing gasket 140 to seal incoming fluid to be filtered from outgoing filtered fluid.

The head 102 further includes a quick connect mechanism 160 that is used to detachably fix the filter 100 to the head 102. In the illustrated example, the quick connect mechanism 160 is an external lock construction that in use surrounds the first end 120 of the filter 100 when the filter is inserted into the head 102. In one embodiment, the quick connect mechanism 160 is a ball lock construction where the locking elements are in the form of a plurality of circumferentially spaced locking balls 164. The balls 164 are radially displaceable with their radial displacement being controlled by a rotatable radial displacement control element 166 in the form of a rotatable retaining ring.

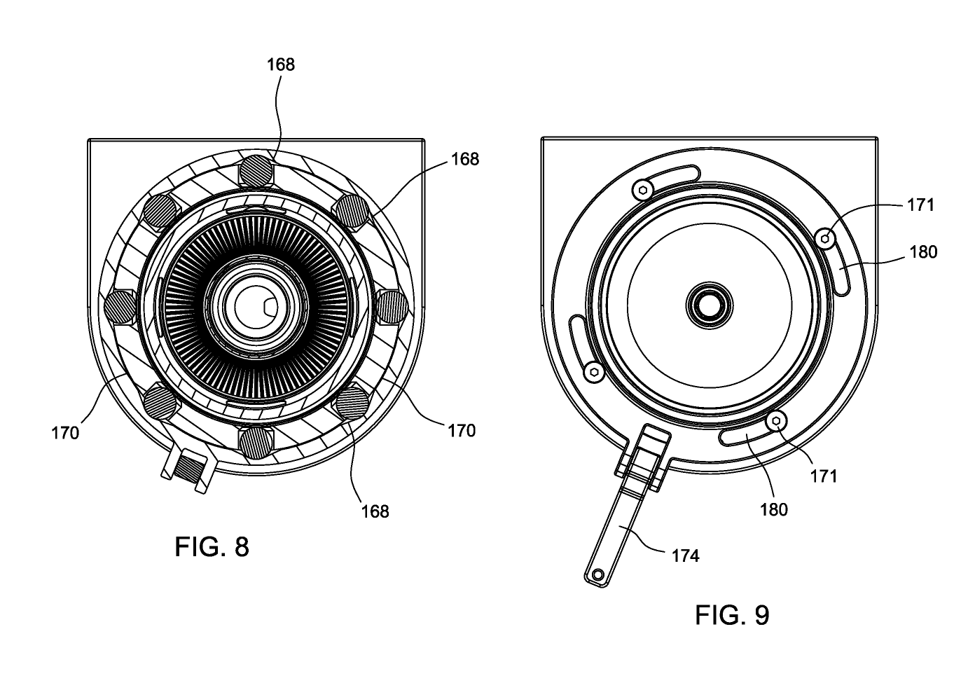

The quick connect mechanism 160 is similar in construction to the quick connect mechanism 60 of FIGS. 1-5, in that the mechanism 160 includes the locking balls 164 disposed within suitable holes 165 in a skirt portion 162 of the head to allow the balls to move radially inward and outward, controlled by the control element 166. However, the mechanism 160 includes more balls 164 than the mechanism 60. In the illustrated example, there are eight of the locking balls 164 that are circumferentially spaced from each other (FIG. 8). However, a smaller or larger number of locking balls could be used.

The control element 166 is mounted on and surrounds the skirt portion 162 and the balls 164 and is mounted on the skirt portion 162 to allow the control element 166 to rotate relative to the skirt portion 162 between a locked position (not shown) and an unlocked position shown in FIGS. 6-9. As best seen in FIG. 8, the control element 166 has circumferentially alternating regions of differing radial thicknesses, with thin radial thickness regions 168 and regular or thick (i.e. thick relative to the regions 168) radial thickness regions 170. With reference to FIG. 8, at the unlocked position of the control element 166, the regions 168 are positioned opposite the balls 164 which allows the balls 168 to move radially outward. However, when the control element 166 is rotated (for example counterclockwise in FIG. 8) to the locked position, the regions 170 force the balls 64 to move radially inward to retain the balls within the locking channel 124.

As with the mechanism 60, the control element 166 is mounted to the skirt portion 162 via screws 171 that extend through slots 180 formed in the base of the control element 166 and thread into suitable threaded apertures in the end of the skirt portion 162. The slots 180 allow the control element 166 to rotate relative to the skirt portion 162, with the ends of the slots 180 also acting as stops to control the amount of rotation of the control element 166. However, other rotation control features could be utilized.

Rotation of the control element 166 is preferably done manually in a manner similar to the control element 66, by using a lever arm 174 that is pivotally mounted to the control element 166 for rotation approximately 90 degrees between a rotation position (shown in FIG. 9) for use in rotating the control element 166, and a locked position (shown in FIGS. 1-5). The lever arm 174 can also include a lock tab similar to the lock tab 76.

Operation of the embodiment in FIGS. 6-9 is similar to the operation of the embodiment in FIGS. 1-5.

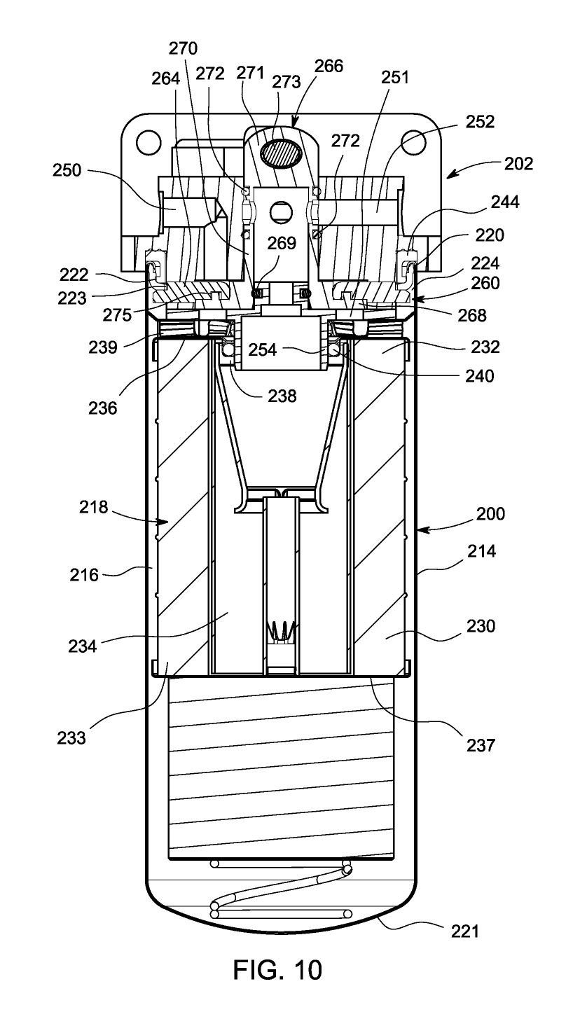

FIGS. 10-14 illustrate another embodiment of a fluid filter 200 and a filter head 202. As with the embodiments illustrated in FIGS. 1-5 and 6-9, the filter head 202 includes a quick connect mechanism 260. But in this embodiment, the quick connect mechanism in the form of an internal pin lock construction.

In the illustrated example, the fluid filter 200 includes a shell 214 defining an interior space 216. A filter cartridge 218 is disposed within the interior space. In this embodiment, the shell 214 and the cartridge 218 are integrally fixed to one another such that during servicing, the entire fluid filter 200 is intended to be discarded and replaced with a new shell and filter cartridge during servicing.

The shell 214 can be made of any material suitable for use in a fluid filter. Examples of materials include metal and plastic. The shell 214 can be generally cylindrical in shape and includes a wall having a first, open end 220 and a second, closed end 221. A plate 222 is fixed to the shell at the open end 220. The plate 222 has an inner edge 223 that defines a central opening of the plate 222 and of the filter 200. A circumferentially continuous, radially inward facing interior locking channel 224 is formed between the plate 222 and an upper end of the filter cartridge 218. The channel 224 is configured to receive locking elements of the quick connect mechanism 260 described further below.

With reference to FIG. 10, the filter cartridge 218 includes a ring of filtration media 230 having a first end 232 and a second end 233 and circumscribing a central cavity 234 having a longitudinal axis. An endplate 236 is fixed to the first end 232 to close the first end of the media 230. An endplate 237 is also fixed to the second end 233 of the media to close the second end.

The endplate 236 has a central opening 238 that is in fluid communication with the central cavity 234 of the media 230. The central opening 238 includes a radially inward facing o-ring sealing gasket 240 that seals with the outside surface of a post 254 extending from the head 202.

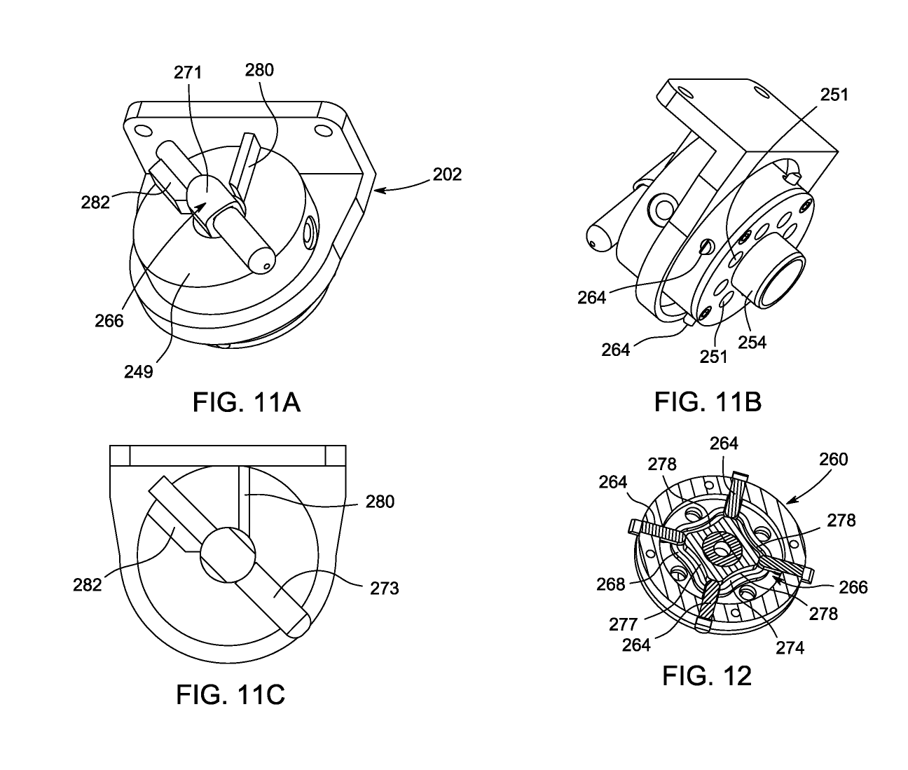

The endplate 236 further includes a plurality of standoffs 239 that extend upwardly therefrom which form fluid passageways to allow fluid to flow along the top end of the filter cartridge 218. Incoming fluid to be filtered flows into an inlet 250 in the head 202, down through vertical passageways 251 in the head (see FIG. 11b), radially outwardly through the standoffs 239, and then into a space between the outer side of the filter media 230 and the wall of the shell 214. In the illustrated example, the filter cartridge is designed for outside in fluid flow, with the space between the outer side of the filter media 230 and the wall of the shell 214 being an unfiltered fluid side and the central cavity being a filtered fluid side. However, the filter cartridge could be designed for inside out fluid flow, with the central cavity 234 being an unfiltered fluid side and the space between the outer side of the filter media 230 and the wall of the shell 214 being a filtered fluid side.

A sealing gasket 244 at the end of the filter 200 seals with the head 202 when the filter is installed.

The head 202 includes a housing 249 that defines an interior space that in use receives a portion of the fluid filter 200 therein. The housing 249 includes the fluid inlet 250 and a fluid outlet 252 that is in fluid communication with the central cavity 234 via the central opening 238. The fluid outlet post 254 is generally hollow and filtered fluid flows through the post 254 to the outlet 252.

The head 202 further includes the quick connect mechanism 260 that is used to detachably fix the filter 200 to the head 202. In the illustrated example, the quick connect mechanism 260 is an internal lock construction that in use is disposed within the filter 200 at the first end 220. In one embodiment, the quick connect mechanism 260 is a pin lock construction where the locking elements 264 are in the form of a plurality of circumferentially spaced locking pins. The pins 264 are radially displaceable with their radial displacement being controlled by a rotatable radial displacement control element 266 in the form of a rotatable cam mechanism that is rotatably disposed on the head.

With reference to FIGS. 10-12, the control element 266 comprises a cam plate 268 whose inner periphery is sealed with the outside surface of the post 254 by a seal 269. A post 270 extends upwardly from the cam plate 268 and has an upper end 271 thereof that projects beyond the top of the housing 249 of the head 202. A pair of o-ring seals 272 are disposed on each side of the outlet 252 to prevent leakage of the filtered fluid. The post 270 is generally hollow, except for the upper end 271 which is solid. A pin 273 extends through the upper end 271 which is used to manually rotate the post 270 and the cam plate 268.

As best seen in FIGS. 12 and 14, the cam plate 268 includes a recessed track 274 formed therein. The radially inner ends of the pins 264 are notched 275 (FIG. 10) so that the innermost end of each pin 264 rides in and follows the track 274, and the notch 275 rides on an outer ridge 276 that helps to define the outer perimeter of the track 274. The inner perimeter of the track 274 is defined by an outer edge 277 of a central portion of the cam plate 268. The track 274 defined by the ridge 276 and outer edge 277 is formed with circumferentially alternating regions where the radius of the track changes, with smaller radius regions 278 and larger radius regions 279.

The locking pins 264 are disposed within suitable radial holes 265 in the head to allow the pins 264 to move radially inward and outward, controlled by the control element 266. In the illustrated example, there are four of the locking pins 264 that are circumferentially spaced from each other. However, a smaller or larger number of locking pins could be used.

When the control element 266 is rotated to an unlock position (shown in FIG. 14), the locking pins 264 follow the track 274 and are retracted radially inwardly by the control element because the ends of the pins are disposed at the smaller radius regions 278. This permits the filter 200 to be removed and a new filter to be installed. When the control element 266 is rotated to a lock position (shown in FIG. 12), the locking pins 264 follow the track 274 and are extended radially outwardly by the control element because the ends of the pins are disposed at the larger radius regions 279. At the locked position, the outer ends of the pins project outwardly from the head and into the lock channel 224 to lock the filter 200 to the head 202 (FIG. 10).

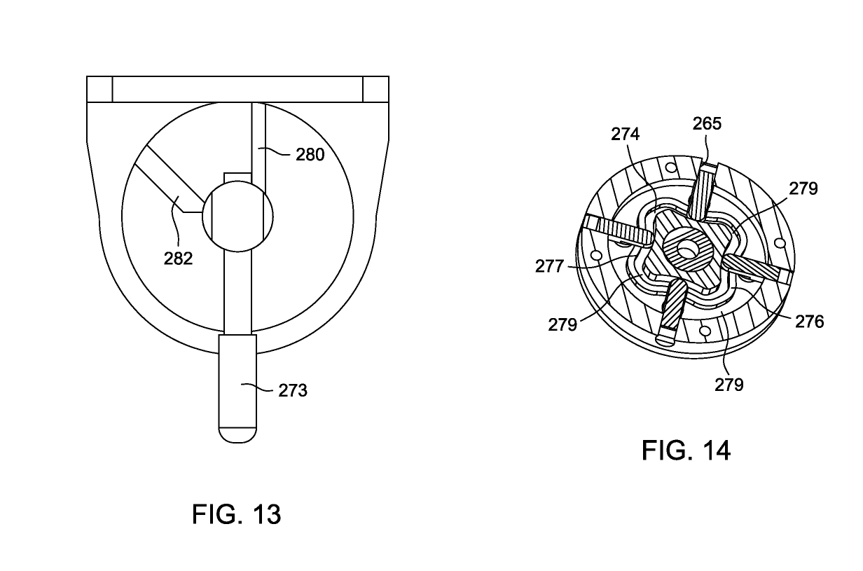

With reference to FIGS. 11a, 11c and 13, the housing 249 can includes a pair of ribs 280, 282 that extend upwardly therefrom. The ribs 280, 282 act as stops to engage with the pin 273 and limit rotation of the control element 266. The rib 282 acts as the stop to define the locked position, while the rib 280 acts as the stop to define the unlocked position.

As shown in FIG. 13, in one embodiment, the pin 273 can be extendable/retractable relative to the end 271 of the control element 266. FIG. 13 illustrates the pin 273 in an extended state. A spring or other bias means can be provided in the end 271 to return the pin to a retracted state shown in FIGS. 11a and 11c. Making the pin 273 extendable makes it easier for the user to actuate the control element 266 by making the pin more accessible to the user and by increasing the rotational torque that can be applied to the control element 266.

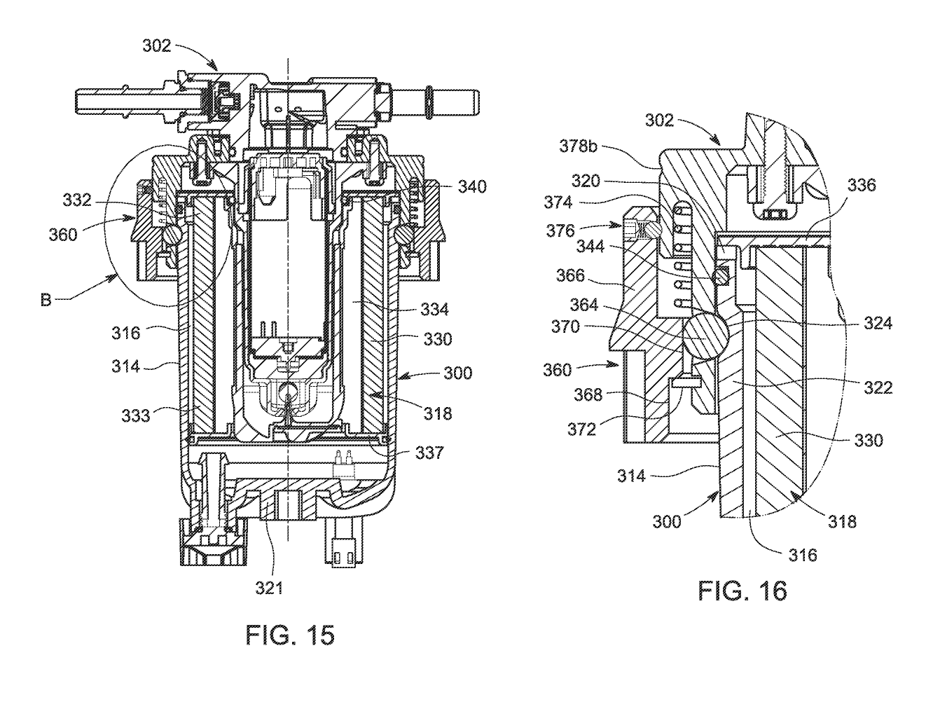

With reference to FIGS. 15-17, another embodiment of a fluid filter 300 and a filter head 302 are illustrated. As with the embodiments illustrated in FIGS. 1-14, a quick connect mechanism 360 is provided to connect the fluid filter 300 to the head 302.

In FIGS. 15-17, the fluid filter 300 includes a shell 314 defining an interior space 316. A replaceable filter cartridge 318 is removably disposed within the interior space. In this embodiment, during servicing, the shell 314 is intended to be reused and the filter cartridge 318 is removed and replaced with a new filter cartridge. In another embodiment, the entire fluid filter 300 can be discarded and replaced with a new shell and filter cartridge during servicing, in which case the shell and filter cartridge can be permanently connected to one another or the filter cartridge can be removable from the shell.

The shell 314 can be made of any material suitable for use in a fluid filter. Examples of materials include metal and plastic. The shell 314 can be generally cylindrical in shape and includes a wall having a first, open end 320 and a second, closed end 321. The wall of the shell 314 has an enlarged thickness section 322 adjacent to the open end 320. A circumferentially continuous, generally semi-circular, radially outward facing exterior locking channel 324 is formed in the enlarged thickness section 322. The channel 324 is configured to engage with locking elements of a quick connect mechanism described further below.

With continued reference to FIGS. 15-16, the filter cartridge 318 includes a ring of filtration media 330 having a first end 332 and a second end 333 and circumscribing a central cavity 334 having a longitudinal axis. An endplate 336 is fixed to the first end 332 to close the first end of the media 330. An endplate 337 is also fixed to the second end 333 of the media to close the second end.

The endplate 336 has a central opening that is in fluid communication with the central cavity 334 of the media 330. The central opening includes a sealing gasket 340, for example an o-ring seal, that seals with the head 302 to prevent fluid leakage between the clean and dirty sides of the filter. In addition, a circumferential sealing gasket 344 is disposed on the shell 314 adjacent to the open end 320. The gasket 344 provides a seal between the filter 300 and the head 302 to prevent fluid leakage to the exterior. In the illustrated embodiment, the seal 344 is spaced from and not disposed within the locking channel 324.

In the illustrated example, the filter cartridge is designed for outside in fluid flow, with the space between the outer side of the filter media 330 and the wall of the shell 314 being an unfiltered fluid side and the central cavity being a filtered fluid side. However, the filter cartridge could be designed for inside out fluid flow, with the central cavity 334 being an unfiltered fluid side and the space between the outer side of the filter media 330 and the wall of the shell 314 being a filtered fluid side.

The head 302 includes a housing that defines an interior space that in use receives a portion of the fluid filter 300 therein. The housing includes a fluid inlet that is in fluid communication with the interior space and a fluid outlet that is in fluid communication with the central cavity 334 via the central opening in the endplate 336.

The head 302 further includes the quick connect mechanism 360 that is used to detachably fix the filter 300 to the head 302. In the illustrated example, the quick connect mechanism 360 is an external lock construction that in use surrounds the first end 320 of the filter 300 when the filter is inserted into the head 302. In one embodiment, the quick connect mechanism 360 is a ball lock construction where the locking elements are in the form of a plurality of circumferentially spaced locking balls 364. The balls 364 are radially displaceable with their radial displacement being controlled by an axially displaceable control element 366 in the form of an axially movable retaining ring.

The quick connect mechanism 360 is similar in construction to the quick connect mechanism 60 of FIGS. 1-5, in that the mechanism 360 includes the locking balls 364 disposed within suitable holes in a skirt portion of the head to allow the balls to move radially inward and outward, controlled by the control element 366. Any number of locking balls could be used, such as four or more.

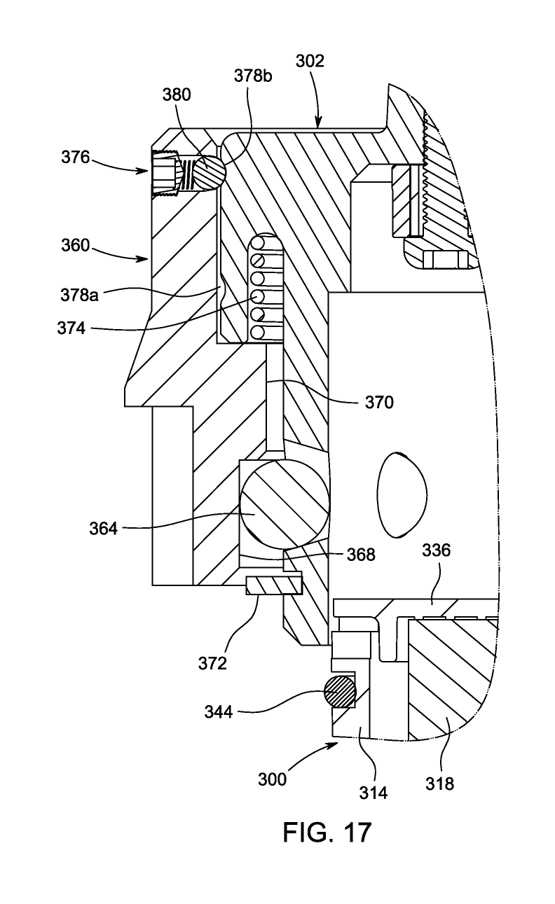

The control element 366 is mounted on the head and surrounds the skirt portion and the balls 364 and is mounted on the head to allow the control element 366 to move axially relative to the skirt portion between a locked position (FIGS. 15 and 16) and an unlocked position shown in FIG. 17.

The control element 366 has a large diameter section 368 that allows the balls to move radially outwardly at the unlocked position and a smaller diameter section 370 that keeps the balls from moving radially outward. A circlip 372 is provided on the skirt portion of the head that abuts against a shoulder formed between the sections 368, 370 when the control element is at the locked position to retain the control element around the head 302. A biasing spring 374 surrounds the skirt portion and acts on the control element 366 to bias the control element 366 downwardly toward the locked position. However, the control element 366 can be manually pushed upward against the bias of the spring 374 to move the control element to the unlocked position with the larger diameter section 368 opposite the balls to allow the balls to move radially outwardly.

To prevent inadvertent or unintentional movements of the control element 366, a keeper mechanism 376 can be provided on the control element 366. In the illustrated example, the keeper mechanism 376 comprises a pair of circumferentially continuous, radially outward facing grooves 378a, 378b (best seen in FIG. 17) formed in the head. A spring biased ball 380 is provided in the control element 366 that can seat in the grooves 378a, 378b at the locked position and the unlocked position, respectively, of the control element 366 to help retain the control element at the respective position. However, the retention force provided by the keeper mechanism 376 can be overcome by manual force of a user manually raising or lowering the control element.

In use, from the position shown in FIG. 15, the control element 366 is manually raised upward or axially against the bias of the spring 374 until the larger diameter section 368 is opposite the balls as shown in FIG. 17. The balls 364 can then move radially outwardly out of the locking channel 324 to allow removal of the filter 300. Connection is achieved in the opposite manner with the new filter being inserted, and the control element 366 being manually moved downward to the locked position. The smaller diameter section 370 forces the balls radially inwardly into the locking channel 324 to lock the filter to the head.

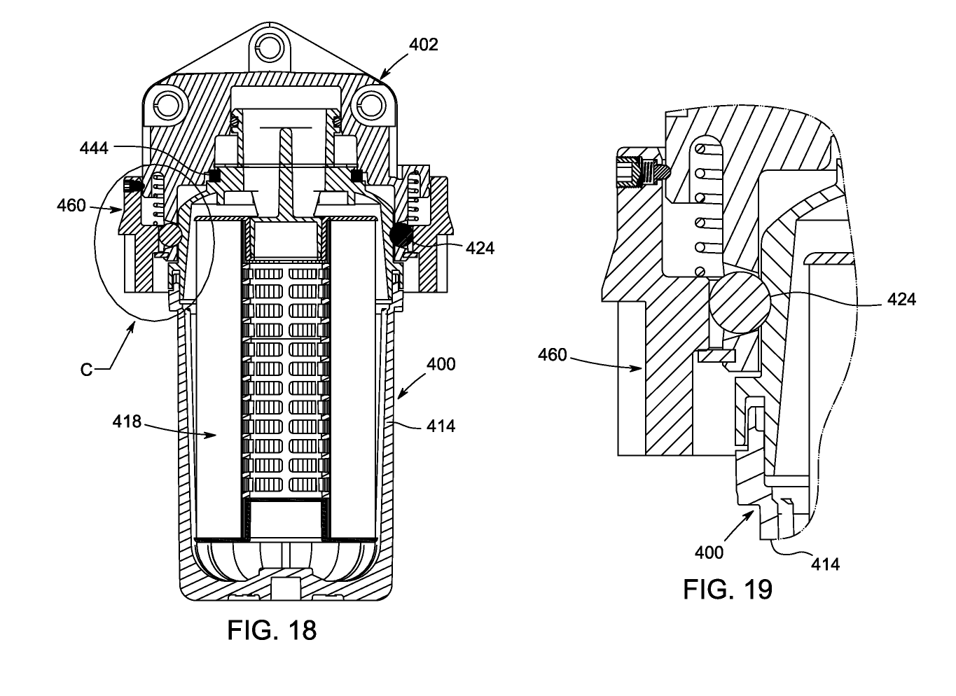

With reference to FIGS. 18-19, another embodiment of a fluid filter 400 and a filter head 402 are illustrated. This embodiment uses a quick connect mechanism 460 that is similar or identical in construction and operation to the quick connect mechanism 360. However, in this embodiment, the filter 400 differs from the filter 300.

In this embodiment, the filter 400 includes a shell 414 and a filter cartridge 418. However, the entire fluid filter 400 can be discarded and replaced with a new shell and filter cartridge during servicing. The shell 414 includes a circumferentially continuous, generally semi-circular, radially outward facing exterior locking channel 424 that is configured to engage with the locking elements of the quick connect mechanism 460.

In addition, a circumferential sealing gasket 444 is disposed on the shell 414 that provides a seal between the filter 400 and the head 402 to prevent fluid leakage to the exterior. Further information on the construction of the filter 400 and its interaction with the head, except for the quick connect mechanism, can be found in U.S. Patent Application Publication 2010/0200490, which is incorporated herein by reference in its entirety.

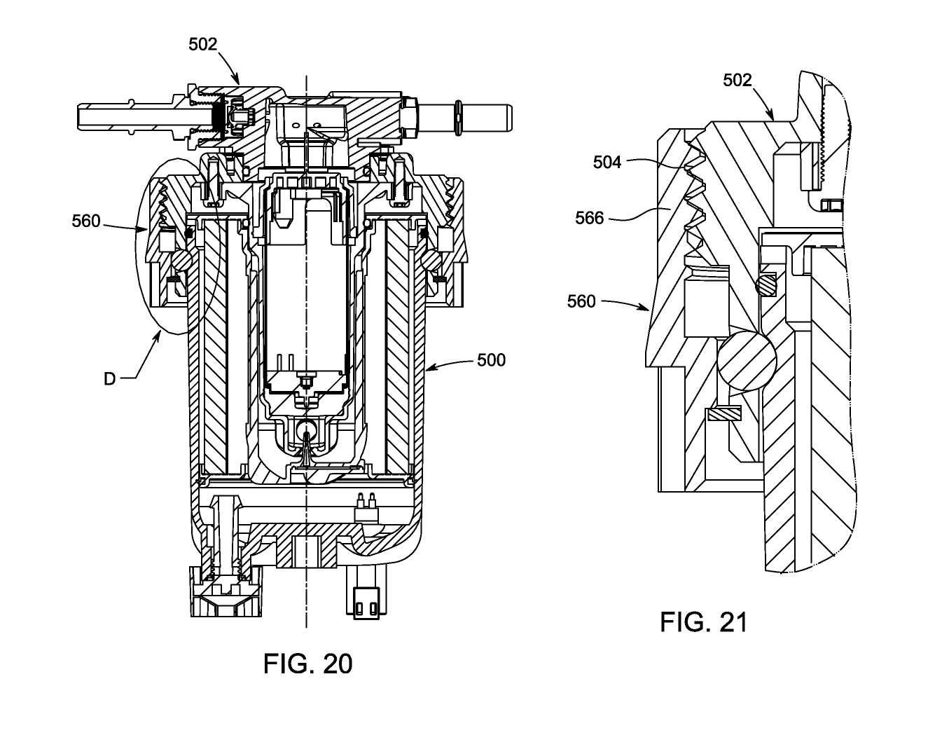

FIGS. 20 and 21 illustrate an embodiment with a fluid filter 500 and a filter head 502 similar in construction to the fluid filter and filter head in FIGS. 15-17. However, in this embodiment, the control element 566 of the quick connect mechanism 560 is attached to the head 502 via threads 504. Rotation of the control element 566 relative to the head 502 causes the control element to move axially upward due to the threads 504 to an unlocked position where the larger diameter section of the control element is opposite the balls, allowing the balls to displace radially outwardly to disconnect the filter. When the control element 566 is rotated in the opposite direction, the threads 504 cause the control element to move axially downward to the locked position shown in FIGS. 20 and 21.

In this embodiment, the biasing spring 374 is not required. In addition, the keeper mechanism 376 is not illustrated as being used.

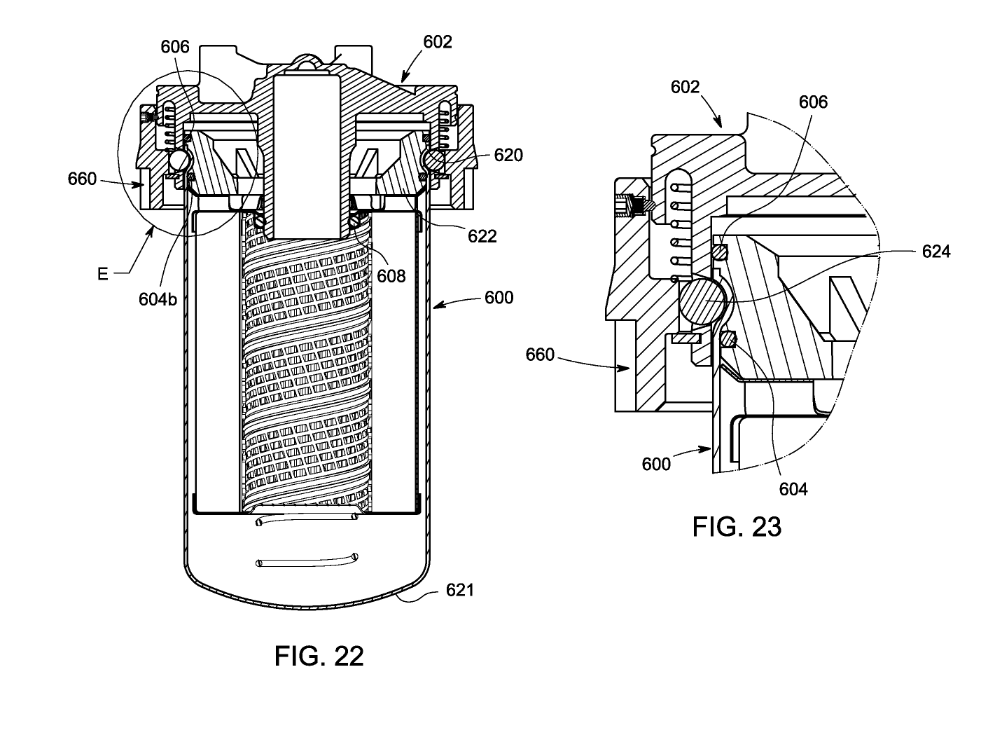

FIGS. 22 and 23 illustrate an embodiment with a fluid filter 600 and a filter head 602. In this embodiment, the head 602 and the quick connect mechanism 660 are similar in construction to the filter head and quick connect mechanism in FIGS. 15-17.

The fluid filter 600 shares similarities with the filter 200 in FIG. 10. In the illustrated example, the fluid filter 600 includes a shell defining an interior space with a filter cartridge disposed within the interior space. In this embodiment, the shell and the cartridge are integrally fixed to one another such that during servicing, the entire fluid filter 600 is intended to be discarded and replaced with a new shell and filter cartridge during servicing.

The shell is generally cylindrical in shape and includes a wall having a first, open end 620 and a second, closed end 621. A plate 622 is fixed to the shell at the open end 620. The plate 622 is fixed to and sealed with the shell via a seal 604. Another seal 606 is located on the plate 622 to seal with the head 602. A third seal 608 on the filter cartridge seals with a tubular fluid passage, such as an outlet passage, of the head.

The shell includes a circumferentially continuous, generally semi-circular, radially outward facing exterior locking channel 624 that is configured to engage with the locking elements of the quick connect mechanism 660.

The control elements described herein can be formed of any suitable material including, but not limited to, metal or plastic. If wear between the control element and the locking elements, for example the balls or the locking pins, may be an issue, the control element can be suitably reinforced. For example, in a case where the control element is made of plastic, a steel ring can be provided, for example co-molded in the plastic control element, at a location thereon that engages with the balls or pins to prevent wear on the plastic of the control element. In another example, if the control element is made of metal, then if wear may be a problem the metal of the control element can be locally case hardened in the contact area with the balls or pins.

The various concepts and features described in the embodiments of each of FIGS. 1-5, FIGS. 6-9, FIGS. 10-14, FIGS. 15-7, FIGS. 18-19, FIGS. 20-21, and/or FIGS. 21-22, can be used individually or in any combination with one or more of the other embodiments.

The described embodiment(s) may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A fluid filter, comprising:
a generally cylindrical shell defining an interior space, the shell includes a first end and a second end;
a circumferentially continuous, radially outward facing locking channel formed in the shell adjacent to the first end;
a seal at or adjacent to the first end for sealing with a filter head; and
a filter element disposed within the interior space of the shell.

2. (canceled)

3. (canceled)

4. The fluid filter of claim 1, wherein the seal is disposed on the filter element.

5. The fluid filter of claim 1, wherein the seal is disposed on the shell.

6. The fluid filter of claim 1, wherein the filter element is removably disposed within the shell so that the filter element can be removed and replaced with a new filter element.

7. The fluid filter of claim 1, wherein the filter element is integral with the shell so that both the shell and the filter element are disposable together.

8. The fluid filter of claim 1, wherein the locking channel is disposed between the seal and the second end.

9. A fluid filter system, comprising:
a fluid filter that includes:
a generally cylindrical shell defining an interior space, the shell includes a first end and a second end;
a circumferentially continuous, radially outward facing locking channel formed in the shell adjacent to the first end; a seal at or adjacent to the first end for sealing with a filter head; and
a filter element disposed within the interior space of the shell; and
a filter head to which the fluid filter mounts, the filter head includes a quick connect mechanism that engages with the locking channel to detachably connect the fluid filter to the filter head.

10. (canceled)

11. (canceled)

12. The fluid filter system of claim 9, wherein the seal is disposed on the filter element.

13. The fluid filter system of claim 9, wherein the seal is disposed on the shell.

14. The fluid filter system of claim 9, wherein the filter element is removably disposed within the shell so that the filter element can be removed and replaced with a new filter element.

15. The fluid filter system of claim 9, wherein the filter element is integral with the shell so that both the shell and the filter element are disposable together.

16. The fluid filter system of claim 9, wherein the quick connect mechanism comprises a plurality of radially displaceable locking elements having a locked position and an unlocked position.

17. The fluid filter system of claim 16, wherein the quick connect mechanism further includes a control element that is movably disposed on the filter head for movement between an unlocked and a locked position, the control element is engaged with the locking elements to control a radial position of the locking elements.

18. The fluid filter system of claim 16, wherein the locking elements are circumferentially spaced from one another.

19. The fluid filter system of claim 17, wherein the control element moves axially relative to the filter head between the unlocked position and the locked position thereof, or the control element rotates relative to the filter head between the unlocked position and the locked position thereof.

20. A filter head configured for connection to a fluid filter, the filter head comprising:
a housing defining an interior space that in use receives a portion of the fluid filter therein, the housing includes a fluid inlet and a fluid outlet;
a quick connect mechanism mounted on the housing, the quick connect mechanism includes a plurality of radially displaceable locking elements having a locked position and an unlocked position, and a control element that is movably disposed on the housing for movement between an unlocked position and a locked position, the control element is engaged with the locking elements to control a radial position of the locking elements.

21. The filter head of claim 20, wherein the locking elements are circumferentially spaced from one another.

22. The filter head of claim 20, wherein the control element moves axially relative to the housing between the unlocked position and the locked position thereof, or the control element rotates relative to the housing between the unlocked position and the locked position thereof.
